(19) United States
(12) Patent Application Publication
(10) Pub. No.: US 2013/0025628 A1
(43) Pub. Date: Jan. 31, 2013

(54) SCOURING BODY

(71) Applicants: Sebastian Bauer, Vaterstetten (DE); Marc Hunger, Viernheim (DE)

(72) Inventors: Sebastian Bauer, Vaterstetten (DE); Marc Hunger, Viernheim (DE)

(73) Assignee: CARL FREUDENBERG KG, Weinheim (DE)

(21) Appl. No.: 13/576,422

(22) PCT Filed: Apr. 19, 2011
(86) PCT No.: PCT/EP2011/001966

§ 371 Date: Aug. 1, 2012

(30) Foreign Application Priority Data
Apr. 22, 2010 (DE) 10 2010 018 169.2

(51) Int. Cl. A47L 13/16; B08B 1/00; A47L 13/10

(52) U.S. Cl. 134/6; 15/118

(57) ABSTRACT

A scouring body which comprises a sponge body and a sheet like textile structure arranged on the sponge body, wherein the cleaning surface of the sheet-like textile structure is sealed, strengthened and provided with scouring particles by means of a binder, is described. The scouring particles comprise plastic particles. The scouring body is characterized by an extraordinarily high cleaning power, washing stability and hydrolysis resistance.

### CROSS REFERENCE TO RELATED APPLICATIONS

This is the U.S. National Phase Application under 35 U.S.C §371 of International Patent Application No. PCT/EP2011/001966 filed Apr. 19, 2011, which designated the United States and was published in a language other than English, which claims the benefit of German Patent Application No. 10 2010 018 169.2 filed on Apr. 22, 2010, both of them are incorporated by reference herein.

### FIELD OF THE INVENTION

The invention concerns a scouring body, including a sponge body and a flat textile structure disposed on the sponge body, in which the surface of the flat textile structure seals by means of a binder, stiffens, and is provided with scouring particles, characterized in that the scouring particles consist of particles of a synthetic material.

### BACKGROUND

In the trade, scouring bodies with a square sponge body are available which exhibit a cleaning surface on at least one side. What is more, the cleaning surface is made up of a fiber layer made of polymer fibers, which is disposed on the sponge body. In order to improve the cleaning power, the fiber layer exhibits scouring particles, which are fixed to the fibers by means of a binder. Inorganic materials are used, as a rule, as the scouring particles, such as finely ground quartz or powdered glass granulate, due to their high hardness.

A scouring body made of metal wool is known from WO 2008/123880 A1, which can also contain a portion of polymer fibers. The metal fibers and, as applicable, any polymer fibers present are, according to the publication, coated with a scouring composition of binder and scouring particles, in which the scouring particles can contain soft, large-sized particles of plastic and hard, small-sized scouring particles of inorganic materials. The known scouring body is supposed to be suitable, in particular, for scouring and polishing wood or metal surfaces, especially of pots and pans.

A scouring body of the type mentioned at the start, which is particularly suitable for cleaning glass or ceramic-glass surfaces and is provided with scouring particles of glass granulate, is known from DE 10 2006 005 160 A1. This scouring body is distinguished in particular by the fact that its cleaning surface is sealed by applying a binder against the penetration of cleaning fluid. As a result, the cleaning fluid is not absorbed, but remains on the surface to be cleaned and contributes to better break-up and removal of dirt particles. Furthermore, the binder composition is selected such that the cleaning surface is designed to be resistant to bending. Thus, especially good transfer of force and improved cleaning action against solidly attached dirt occur.

### SUMMARY

The invention is based on the task of making available a scouring body of the type cited at the start, the cleaning power of which is still further improved over prior art and which, in addition, is easy to clean and is highly stable in hydrolysis and washing.

This task is achieved with a scouring body, including a sponge body and a flat textile structure disposed on the sponge body, is sealed by means of a binder, hardened, and provided with scouring particles, characterized in that the scouring particles include particles made of a plastic.

A scouring body according to the invention includes a flat textile structure, which is disposed on a sponge body and exhibits a cleaning surface, in which the surface of the flat textile structure seals by means of a binder, hardens, and is provided with scouring particles. According to the invention, the scouring particles include particles of plastic.

It has been shown, surprisingly, that plastic particles, in spite of their hardness, are suitable for loosening or breaking up stubborn dirt residue, if they are disposed on a sealed surface that is relatively resistant to bending. The invention thereby makes use of the fact that scouring particles cannot be pressed into a closed, sealed surface resistant to bending by exerting pressure on the surface material, as in the case, for example, with the scouring body of metal wool described, which exhibits a relatively flexible, open surface structure or the open-pored, abrasive fiber framework known from prior art. With the scouring body according to the invention, the scouring particles are pressed instead into the dirt when exerting pressure and can break it up better.

More advantageously, the plastic particles exhibit sharp edges, with which stubborn dirt residue can be broken up and removed. Rough-edged plastic particles can be achieved in a known manner by grinding or breaking.

Preferably, particles made of a plastic are used, which exhibit a Mohs hardness of roughly 3-4. It is therewith ensured that the scouring particles are hard enough to break up hard, severely encrusted dirt residue.

It has been proven that large particles of dirt break up best. Particle sizes between roughly 100 μm and 400 μm are preferred. Such particles are about 5 to 20 times larger than the quartz particles known from prior art.

It has been proven to be advantageous to add to the scouring particles made of plastic small amounts of particles of a fine-grained inorganic material (5 wt. % to 50 wt. % relative to the solid content of the abrasive layer provided with the binder and the scouring particles), preferably finely ground quartz with high fines (particle diameter roughly 40 to 90 μm). These particles serve to essentially rough up the surface, since the dirt crust is broken up.

As a plastic material for the scouring particles, melamine resin, in particular, has proven to be very suitable, because it can be very well integrated into the binder matrix. The scouring body is thereby mechanically and thermally stable to an exceptional degree and is even distinguished, in addition, by a pronounced high stability in washing.

Further suitable materials for the plastic particles are, without any restriction in general features, polymethyl methacrylate, urea resin, hard polyurethane foam (ground-up), and phenolic resin.

According to the invention, the surface of the flat textile structure is sealed and closed. The sealed and closed surface ensures that no dirt particles can penetrate into the flat textile structure. The scouring body can thus be easily cleaned. Attached dirt particles fall off easily.

Sealing can occur in the same way as the plastic particles are linked, by means of a binder.

In principle, all the usual binders are suitable for this. The binder can, for instance, be latex-, phenolic resin-, and/or acrylate-based. A phenolic resin-based binder exhibits great hardness and high abrasion resistance. Latex-based binders exhibit high elasticity. Mixtures of latex and phenolic resin binders exhibit high resistance to bending due to the phenolic resin, in which the bending resistance due to the latex portion is reduced so much that the scouring body can be wrung out well.

Preferably, the binder is acrylate-based. It has been shown, surprisingly, that with the use of an acrylate binder, not only is the linking of the melamine resin particles, for instance, to the cleaning surface of the flat textile structure very good, but even a considerably improved machine washability of the scouring body is also achieved. Also, after several machine washes, unlike when using the customary binders, no tearing of the cleaning surface occurs. The fitness of the scouring body for use is thereby increased. In addition, acrylate-based binders exhibit a comfortable grip.

In a further embodiment, the binder can consist of a mixture of acrylate and phenolic resin. For one thing, a phenolic resin binder leads to very good linking of any quartz particles added as applicable. For another thing, specific properties of the flat textile structure, such as, for example, grip and hardness, can be affected by the proportions of the two binders, within wide bounds. What is more, the binder is preferably to be formed on the flat structure so that the flat structure is essentially impermeable to water. Thus, when cleaning, a film of cleaning fluid remains between the flat structure with the scouring-agent composition and the surface to be cleaned. Dirt is dissolved in the cleaning fluid and protected and effective cleaning of the surface to be cleaned occurs. Also, the bending resistance of the cleaning surface can be adjusted by means of the binder, so that especially good transfer of force and improved cleaning action against solidly attached dirt are achieved.

Preferably, a binder on an acrylate/phenolic resin base is applied, in which the proportion of acrylate, relative to the solids content of the abrasive layer provided with binder and scouring particles, amounts to at least 20 wt. %, preferably at least 30 wt. %, and especially preferred at least 50 wt. %.

Not only can the best linking of the melamine resin and the finely ground quartz particles be therewith achieved, the bending resistance of the surface is also adjusted so that the best cleaning action is attained.

Further possible binders are melamine resin, nitrile rubber, polyurethane, or combinations of any of the binders cited.

The flat textile structure is preferably made out of a fleece material of synthetic fibers, viscose, and/or cotton. Hardening can occur chemically, mechanically, and/or thermally in a known manner. Preferably, the flat textile structure is chemically bound.

The thickness of the flat structure is between 0.8 and 3 mm, and the weight per unit area is between 50 and 200 g/mm². Such flat structures exhibit a low weight per unit area and a small thickness with simultaneously high tensile strength. The sponge body forms a supporting body which offers a plurality of grip possibilities. Thus, force can be effectively exerted in different ways on the flat structure provided with the scouring-agent composition, so that good cleaning performance occurs with respect to solidly attached dirt.

According to the invention, the flat textile structure with the scouring particles is disposed on the cleaning surface on a sponge body.

The sponge body can be formed of an open-celled, partially open-celled, or closed-celled synthetic foam or a natural foam. The foam, then, can be formed of polyurethane or viscose, in particular. Foams of these substances can be manufactured cost-effectively and exhibit good mechanical properties, so that they can be gripped easily and can transfer forces. Viscose has a high capacity for water absorption.

The sponge body is preferably designed so that hard-to-reach places can be cleaned efficiently and that, in addition, a plurality of different grip possibilities occur. The sponge body can therewith exhibit, without limitation in general features, for instance, a lemon-shaped, round, or quadrilateral shape, in which the edges can possess a straight or curved contour. The edges lying opposite one another can also be designed congruent to one another, for instance.

The sponge body is usually manufactured from a flat intermediate product by punching or cutting it out with a band saw or circular saw. In this design, a waste-free and thus cost-effective manufacture results for scouring bodies with a curved edge shape.

The sponge body can exhibit a thickness of 0.5 cm to 8 cm, preferably from 2 cm to 5 cm. In particular, with a sponge-body thickness of 4 cm, many grip possibilities and good transfer of force result.

A further flat textile structure can be disposed on the sponge body. The sponge body is preferably designed as block-shaped and exhibits two main surfaces. Then the flat structure with the scouring-agent composition is disposed on a first main surface. Disposed on the second main surface lying opposite the first main surface is the further flat textile structure. This flat structure preferably also consists of a fleece material with synthetic fibers, in which the fleece material is designed so that the further flat structure exhibits high water absorption. The second main surface then serves for the post-treatment of surfaces that have already been cleaned with the first main surface and for fluid absorption.

The further flat structure can include microfibers. Microfibers exhibit a fiber diameter of less than 1 dtex. The flat structures made of microfibers intended for use exhibit high capacity for absorption of fluids such as water and fats.

The cleaning action of the scouring body is, in addition, improved in that the cleaning surface exhibits a three-dimensional surface topography. What is more, the three-dimensional surface structure is preferably formed by alternately disposed nub-like valleys and hills. The nub-like hills here act as a means of breaking up dirt, because upon exerting pressure on the scouring body it acts on the dirt particles by means of the very small surfaces of the nub tips, that is, the force-to-surface ratio is higher than with a conventional scouring body with a flat cleaning surface with a comparable force acting.

It is, in addition, ensured due to the three-dimensional surface topography that the dirt does not clog the abrasive surface. Because the dirt collects between the nubs in the valleys, the scouring process is not impaired.

Preferably, the valleys and hills are produced by means of an embossing method, as is described, in principle, in EP 1 448 361 B1. In the known embossing method, the nub-like hills and valleys project out of the unembossed areas of the flat textile structure, such that the hills or valleys on one side of the flat textile structure form valleys or hills on the other side.

According to a preferred embodiment of the invention, the hills and valleys are disposed grating-like in a two-dimensional dot pattern.

According to an especially preferred embodiment of the invention, the two-dimensional dot pattern is formed by means of adjacent rows of quadrilateral, preferably square, elementary surfaces, which include, respectively, one hill and one valley, in which the hill or valley is disposed in one corner and the valley or hill disposed in the middle of the elementary surface.

It has been shown, surprisingly, that the three-dimensional structure described above is very stable with respect to shape. This brings not only advantages with respect to the service life of a scouring body with such a flat textile structure but, what is more, with respect to its manufacture. The three-dimensional flat structure is moreover manufactured separately, embossed, and provided with the scouring-agent composition consisting of binder and scouring particles, for example by means of spraying. The scouring-agent composition additionally stabilizes the three-dimensional structure.

In a further step, the sponge body is then provided with a glue, and the flat three-dimensional structure is laminated on under the action of heat and pressure. Surprisingly, the three-dimensional structure here remains available. Typical dimensions of such a three-dimensional cleaning surface according to the invention are: peak height/depth of a nub-like hill or valley is about 1 mm to 5 mm, measured from an imaginary plane, which is formed by the surface of the unembossed area to the corresponding side of the flat textile structure. The distance of the tip of a nub-like hill to the nadir of the adjacent valley amounts to approximately 3 mm to 4 mm.

In the following, the manufacture of a scouring body according to the invention is described by way of example, without limitation in general features. First a flat textile structure is manufactured from a fiber material, a fleece material, for example. Hardening the flat textile structure occurs, for instance, by means of water-jet hardening. The nub pattern with hills and valleys can be embossed in an known manner, such as is described in EP 1 448 361 B1. But other known embossing methods can also be used.

The scouring-agent composition is manufactured by mixing the binder composition, e.g. made of acrylate and phenolic resin, with the scouring particles, e.g. made of melamine resin and finely ground quartz, as applicable. The scouring-agent composition is then applied, by spraying it onto the cleaning surface, for example. Spraying the scouring-agent composition onto only one side of the flat textile structure has, besides the advantage of saving material, yet a further advantage, in that the flat textile structure remains flexible and easier to laminate. The flat structure can be heat-treated in a dryer to harden the scouring-agent composition.

Finally, the flat three-dimensional structure consisting of a flat intermediate product, e.g. made of an open-celled, partially open-celled, or closed-celled polyurethane foam material, is laminated on. A polyurethane glue, for example, is used for this. In another embodiment, the foam material can also consist of viscose. Another flat structure is laminated onto the opposite side of the flat intermediate product.

Finally, out of the flat intermediate product is punched the scouring body with straight or curved edges, as applicable, or it is cut out with a bandsaw or circular saw.

A scouring body according to the invention is particularly suited to cleaning household surfaces.

The invention is clarified in detail hereinafter using the figures.

### BRIEF DESCRIPTION OF THE DRAWINGS

FIG. 1 at 200× magnification, a microscope photograph of the cleaning surface of a scouring body according to prior art, with an open fiber structure, in which the fibers are coated with a finely ground quartz/binder composition;

FIG. 2 at the same magnification, a microscope photograph of the cleaning surface of a scouring body according to the invention, with a closed, sealed surface with a scouring-agent composition with melamine-resin particles as scouring particles;

FIG. 3 in a schematic sectional drawing, the three-dimensional surface structure of a preferred embodiment of a scouring body according to the invention.

### DETAILED DESCRIPTION

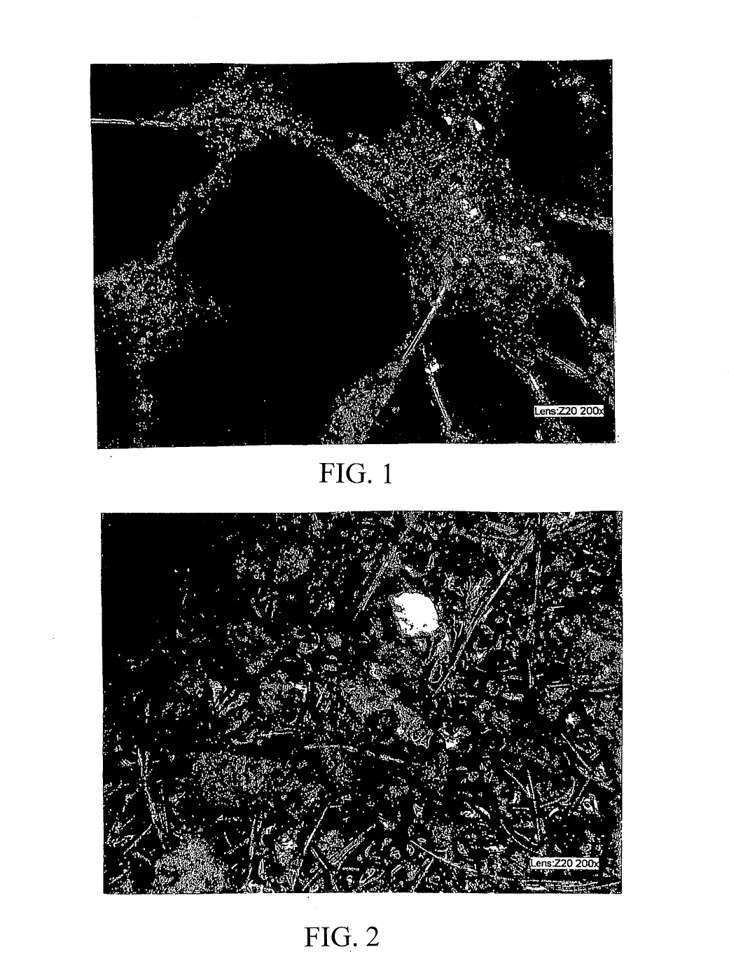

In FIG. 1 the open fiber structure of the cleaning surface can be recognized coated with the scouring-agent composition. The scouring-agent composition sticks in particular to the junction points of the fibers. In addition, it may be recognized that the diameter of the scouring particles, is of the same order of magnitude as the diameter of the fibers, or is substantially smaller. Scouring particle. In contrast, the cleaning surface of a scouring body according to the invention shows, as can be seen in FIG. 2, a closed, sealed surface. The diameter of the melamine-resin particles is considerably larger than the diameter of the fibers. In addition, the melamine-resin particles exhibit sharp edges, which are suited to breaking up solidly encrusted dirt residue.

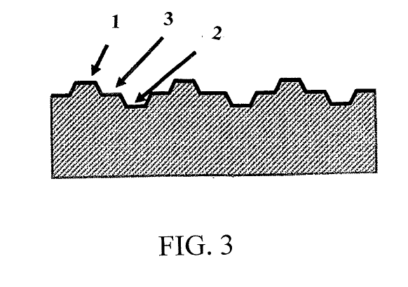

It is apparent from FIG. 3 that with a scouring body according to the invention, with a three-dimensional structure with nub-like hills 1 and valleys 2, which are alternately disposed, planes are formed on the cleaning surface 3: an upper plane which extends through the tips of the hills 1, a middle plane which extends through the unembossed area, and a lower plane which extends through the nadirs of the valleys 2.

Durability tests were conducted in which the respective residual cleaning performance was determined parallel to said planes.

For the durability tests, scouring bodies according to the invention were subjected at their cleaning surface to a load of 2.5 kg over many hundred cycles over a rough surface, and finally the degree of wear on the surface was optically evaluated.

To determine the cleaning performance of the respective scouring bodies, each sponge body was removed from the textile surface with the abrasive coating, in order to be able to better monitor the pressure applied. Then the textile surfaces of the body being tested with the abrasive coating was subjected to a constant pressure over a test item whose soft surfaces had been provided with hard test dirt. Finally, by means of digital photography, the ratio of the soft (abraded) to the hard (not abraded) surfaces was determined, which represents a measure of cleaning performance.

The above tests showed in the result that, in use, the tips of the hills wear out first (upper plane). Nevertheless, cleaning performance is not diminished to the same degree but remains unchanged. It is obvious that with removal of the upper plane, the lower plane has a corresponding effect.

What is claimed is:

1. A scouring body, including a sponge body and a flat textile structure disposed on the sponge body, is sealed by means of a binder, hardened, and provided with scouring particles, characterized in that the scouring particles include particles made of a plastic.

2. The scouring body according to claim 1, wherein the plastic exhibits a Mohs hardness of about 3-4.

3. The scouring body according to claim 1, wherein the particle size of the synthetic particles is between about 100 μm and 400 μm.

4. The scouring body according to claim 1, wherein mixed in with the scouring particles made of plastic are small amounts of particles made of a fine-grained inorganic material, preferably finely ground quartz with high fines.

5. The scouring body according to claim 4, wherein the proportion of particles made of the inorganic material amounts to 5 wt. % to 50 wt. %, relative to the solids content of the abrasive layer provided with binder and scouring particles.

6. The scouring body according to claim 1, wherein the scouring particles include particles made of melamine resin.

7. The scouring body according to claim 1, wherein the binder includes acrylate.

8. The scouring body according to claim 7, wherein the binder includes, besides acrylate, a phenolic resin, in which the proportion of acrylate, relative to the solids content of the abrasive layer provided with binder and scouring particles, amounts to at least 20 wt. %, preferably at least 30 wt. %, and especially preferred 50 wt. %.

9. The scouring body according to claim 1, wherein the sponge body is formed of an open-celled, partially open-celled, or closed-celled synthetic foam or a natural foam.

10. The scouring body according to claim 1, wherein a further flat textile structure is disposed on the sponge body.

11. The scouring body according to claim 10, wherein the further flat textile structure includes microfibers.

12. The scouring body according to claim 1, wherein the sponge body is designed as lemon-shaped, round, or quadrilateral, in which the edges of the quadrilateral sponge body exhibit a straight or curved contour.

13. The scouring body according to claim 12, wherein the edges lying opposite one another are designed congruent with one another.

14. The scouring body according to claim 1, wherein the sponge body exhibits a thickness of 0.5 cm to 8 cm, preferably 2 cm to 5 cm.

15. The scouring body according to claim 1, wherein the cleaning surface exhibits a three-dimensional surface topography.

16. The scouring body according to claim 15, wherein the three-dimensional surface topography is formed by embossed and unembossed areas of the flat textile structure.

17. The scouring body according to claim 16, wherein the embossed area is formed by nub-like hills and valleys, which project out of the unembossed area of the flat textile structure such that the hills or valleys on one side of the flat textile structure form valleys or hills on the other side.

18. The scouring body according to claim 17, wherein the hills and valleys are disposed grating-like in a two-dimensional dot pattern.

19. The scouring body according to claim 18, wherein the two-dimensional dot pattern is formed by adjacent rows of rectangular, preferably square, elementary surfaces, which include, respectively, one hill and one valley, in which the hill or valley is disposed at one corner and the valley or hill disposed in the middle of the elementary surface.

20. Use of the scouring body according to claim 1 for cleaning household surfaces.
